(19) United States
(12) Patent Application Publication
(10) Pub. No.: US 2015/0066685 A1
(43) Pub. Date: Mar. 5, 2015

(54) SYSTEM AND METHOD FOR DIGITAL CONTENT DISCOVERY, RECOMMENDATIONS AND PURCHASING

(71) Applicant: muse IQ, LLC, Brooklyn, NY (US)

(72) Inventor: Sasha Stoikov, Brooklyn, NY (US)

(73) Assignee: muse IQ, LLC, Brooklyn, NY (US)

(21) Appl. No.: 14/186,979

(22) Filed: Feb. 21, 2014

Related U.S. Application Data
(60) Provisional application No. 61/873,352, filed on Sep. 3, 2013.

(51) Int. Cl. G06Q 30/06

(52) U.S. Cl. CPC G06Q 30/0631
USPC 705/26.7

(57) ABSTRACT

A system and method for providing media recommendations to a user is described. A server computing device provides a browsing user with media content recommendation information based on a recommending user's media library. A client computing device, in communication with the server computing device, is provided with a user interface for purchasing media. The recommending user may be provided with a commission when the browsing user browses and/or purchases media content based on the recommending user's recommendation. The recommending user's media library is presented to the purchasing user based on a predefined level of similarity between the purchasing user's media content library and the recommending user's media content library. The recommending user may receive a commission when other users browse the recommending user's media library.

### RELATED APPLICATIONS

This application claims the benefit of U.S. Provisional Application No. 61/873,352, filed Sep. 3, 2013, the entirety of which is hereby incorporated by reference.

### BACKGROUND OF THE INVENTION

Prior to digitally downloadable music, an artists' revenue was generally associated with record, tape and compact disk (“CD”) sales. Much of today's music is purchased or rented through online stores. Per download and/or per play royalties are often minimal, resulting in some artists removing their music from online stores.

The current online music market has two dominant distribution models: 1) downloading songs; and 2) streaming songs. If a user wishes to purchase and download a song, they are typically charged a fixed fee (e.g., 99 cents) for a digital copy of the song such as an MP3 file, AAC, etc. Generally the user may not resell the song, as they could with physical media. In the streaming model, users either pay a monthly recurring fee (e.g. $10/month) or they may listen to songs for free but with the caveat of commercial interruptions. Many online music stores offer millions of music tracks for both purchase and streaming. Some of the online music content providers include: SPOTIFY™, YOUTUBE™, ITUNES™, AMAZON.COM™, GROOVESHARK™, GOOGLE PLAY™, RDIO™, DEEZER™, and LASTFM™. Generally, these online music providers pay royalties to the artists on a per-play and/or per-download basis.

With millions of downloadable songs, users desire powerful tools to provide relevant music recommendations based on a listeners music habits. Some of the online music providers have recommendation systems, often driven by computer algorithms that correlate similarity in songs and/or artists.

Independent music recommendation systems also exist, such as: PANDORA™, SPOTIFY™, SONGZA™, 8TRACKS™, PLAYLISTLOVE™, TASTEBUDS™, MOOSIFY™, PIKI™, and EQUALA™. These music recommendation systems function in various ways, including: 1) manual analysis of song characteristics (e.g. PANDORA'S MUSIC GENOME PROJECT™); 2) genre categorization (e.g. SONGZA™); and 3) manual recommendation from social-media friends (e.g. EQUALA™). Generally, independent music recommendation systems earn revenue through commissions from stores such as iTunes and Google Play.

The recommendation systems from online music providers often use collaborative filtering methods to provide recommendations based on a listener's prior purchases as well as other listeners' purchasing habits. For example, if User A purchased Song X, User A may be provided with a recommendation to purchase Song Y, because Users B and C purchased Songs X and Y. However, Users B and C are not compensated for transactions generated from their purchasing and/or browsing history.

### SUMMARY OF THE INVENTION

The systems and methods described herein may provide recommendations to users by matching them to other users who have a similar sensibility. For example, if User A purchased Songs X and Y, User A may be provided with a recommendation to purchase Song Z, because User B purchased Songs X, Y and Z. Moreover, User B may be compensated for transactions generated from their purchasing and/or browsing history (e.g., when User A browses User B's songs and/or when User A purchases Song Z upon viewing B's songs).

The systems and methods described herein may create a content recommendation portal where users may be matched with each other based on content and similarity of their media content libraries. In one embodiment, a method for providing, via a server communication device, to a browsing user of a client computing device, an interface for browsing media content of a plurality of available media libraries, where each media library may be associated with one or more users of the system. The server computing device may select a recommended media library from the available media libraries to present to the browsing user. The recommended media library may be selected based on a score generated by comparing a least a portion of the browsing user's media library with at least a portion of the recommended media library. The server computing device may present to the browsing user recommended information including media content associated with the recommended media library of the recommending user. In some embodiments, the generated score may be based on one or more of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.

In another embodiment, a system for providing media content to a user is also described. The system includes a server computing device having a processor, for executing content discovery software modules stored on a memory. The system also includes a client computing device communicatively coupled to the server computing device over a network, wherein the client computing device may include a second processor for executing instructions from a machine readable storage. The content discovery software modules may be programmed to provide an interface for browsing media content of a plurality of available media libraries, where each available media library may be associated with one of a plurality of users. The content discovery modules may be further programmed for selecting from the plurality of available media libraries a recommended media library, associated with a recommending user, to present to a browsing user using the client device. The selection of the recommended media library may be based on a score generated by comparing at least a portion of a browsing user media library associated with a browsing user, with at least a portion of the recommended media library. The contend discovery software modules may further be programmed to present, to the client computing device, recommended information including media content associated with the recommended media library of the recommending user. In some embodiments, the generated score may be based on one or more of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.

Another embodiment of the invention provides a non-transitory computer-readable storage device containing a set of instructions that causes a server computer to perform a process. The server computer may provide to a browsing user of the server computer an interface for browsing media content of a plurality of available media libraries, where each available media library may be associated with one of a plurality of users. The server computer may select from the plurality of available media libraries a recommended media library associated with a recommending user to present to the browsing user. The selection of the recommended media library may be based on a score generated by comparing at least a portion of a media library of the browsing user with at least a portion of the recommended media library. The server computing device may present to the client communication device recommended information including media content associated with the recommended media library of the recommending user. In some embodiments, the generated score may be based on one or more of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.

### BRIEF DESCRIPTION OF THE DRAWINGS

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

FIG. 1 illustrates a user interface of an exemplary content discovery system.

FIG. 2 illustrates an exemplary process for discovering and purchasing content using a content discovery system.

FIG. 3 illustrates exemplary software and hardware architecture for providing a content discovery system.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

As described herein, exemplary methods and systems may be implemented as either a standalone content marketplace, or as an improvement to an existing content marketplace or streaming platform. A description herein of a feature in terms of an app, program, system, or method is merely exemplary and not intended to exclude the use of that feature on another implementation of the invention. Any system or method that includes one or more of the features as described herein is intended to be within the scope of the present invention.

Although examples discussed herein may be in terms of music, one can appreciate that the invention is not so limited, and is equally applicable to any content type, such as but not limited to: music, videos, movies, television shows, software applications, books, pictures, paintings, photographs of sculptures, restaurant or bar reviews and/or recommendations, online dating profiles and photos, travel destinations, online editorial content such as articles or editorials, and/or other digital content. The digital content may be copyrighted material (as is often the case for music) or free of copyright (as is the case for travel destinations).

A user may discover an exemplary content discovery application through a web search, an app store (e.g. APPLE ITUNES, GOOGLE PLAY or AMAZON app stores), or through a link, button, or other notification on a music marketplace or platform, or through a link from a website or social media platform such as FACEBOOK™, LINKEDIN™, or MYSPACE™.

When interfacing with a content discovery system, a user may be requested to login or signup. The signup process may request information from the user, such as: name, password, address, payment information, email address, alias, and/or other relevant information. Optionally, a signup process may use a federated identifier or login scheme such as a SPOTIFY ID, GOOGLE ID, APPLE ID, or FACEBOOK ID. If a content discovery system is implemented as a plugin or add-on to another marketplace, platform or social network, signing up may be unnecessary due to the pre-authentication and identification of the user.

After logging in, a user may pre-fund their account and/or enter payment information for future purchases. Account funding may be accomplished by cash, credit card, checks, ACH transfer, gift cards, or other financial means known by those skilled in the art. Accounts may be funded through an award system of “points” or “tokens” based on user actions (e.g. signing up, referring users, listening to music or advertisements, adding or removing songs from their library, etc.)

In another embodiment, public or private access to a user's current music library may be beneficial. Such information may be manually entered and/or automatically gathered. One automated method for gathering a user's music library may include the scanning of a database of a content marketplace or platform. Examples may include: ITUNES, AMAZON, SPOTIFY, GROOVESHARK, GOOGLE PLAY, RDIO, DEEZER, YOUTUBE and LASTFM. Scrobblers may also be used to gather a user's music library information. Throughout this application, the term “scrobbler” refers to an application, generally stored on a local or remote computing device that maintains a historical record of the audio content played on a given device.

In another embodiment, music library information may also be obtained from applications that analyze sound to determine song titles. An example would be the SHAZAM™ sound analyzer app. In one embodiment, the music meta information that may be gathered about each song in a user's music library may include: database location, play count, last played date stamp, user rating, artist, album, title, length, bit rate, format, encoding, album artwork, album artist, composer, genre, composition date, album track number, and/or lyrics.

A content discovery system may charge fees for various tasks and actions. Such fees may be debited from a user's online balance, charged to a payment instrument associated with their account, charged at the time of sale, or debited for a future bill. Bills may be denominated in and/or paid in any national or international currency, including electronic currencies and payment platforms such as PAYPAL™, GOOGLE WALLET™ or in bitcoins.

Likewise, a user may receive payments for actions they take such as: the user adding library information, a second user browsing the first user's library information, or a second user purchasing a song via the user's library. A portion of the song purchase may be credited to the first user's account. Amounts paid may be denominated and/or delivered in any national or international currency, including electronic currencies and payment platforms. A user's account may be credited per transaction, after a predefined period of time, or a predefined amount.

In one embodiment, content discovery systems may use a “muse” or multiple “muses” for offering music recommendations. In one embodiment, a muse may be a member or user of a content discovery system wherein the member's music listening habits (e.g., listening history and/or music library) may be used to offer music recommendations to other members with similar music taste. In other words, the muse may be described as a recommending user, or a user that recommends digital content to a user that requests such content (i.e., a “requesting user”). Because recommendations may be provided by the users of a content discovery system, the strength of such recommendations increases with the number of members. The system may select a muse with which to offer a recommendation in several ways. A muse may be sponsored (e.g. paid for as an advertisement). A muse may also be selected for a purchasing or browsing user by generating a similarity score between the media library of that purchasing or browsing user and the media library of another user in the system. If the similarity score is high enough between the two media libraries, one user may be identified as a muse for the other user.

It will be appreciated that a muse may also be a requesting user when that user is browsing the content discovery system to discover new content. It follows that a first requesting user may also be a muse to a second requesting user who browses the first requesting user's content.

A collaborative filtering method may compile the listening habits of other users (e.g., muses) as a means of providing music recommendations based on past listening history of like-minded listeners. For example, if a user likes song A, they will probably like song B, since numerous other listeners listen to both song A and B. In other words, the effectiveness of a content discovery system may depend, in part, on the number of users associated with the system.

In one embodiment, a content discovery system with a small number of users may benefit from a pre-populated recommendation database having one or more anonymous muses. An exemplary anonymous muse may be associated with a static list of songs, which may be ranked by play count or other means. Anonymous muses may facilitate transactions when matched to real users, even though the muses are not real users. The song list of an anonymous muse may be randomly assigned, or the songs may be assigned based on characteristics, such as but not limited to, genera, format, style, composer, artist, record label, beats per minute, or other characteristics discussed herein or known to those skilled in the art.

Alternately, it may be preferable to populate the song lists of anonymous muses with actual user data. There are various sources of user data that can be used to populate the song list of one or more anonymous muses. For example, THE ECHO NEST™ music service provides anonymous listening data on users of its system. User libraries and play counts may be monitored to create anonymous muses for a content discovery system. As such, publically available data sets of listening habits may be used to create an anonymous muse with a music library. Optionally, providers of listening habit databases may be compensated for access to their databases. For example, data providers may be paid a flat fee for data used to create anonymous muses. Alternately, data providers may be paid for transactions generated from the recommendations of anonymous muses.

An anonymous muse may be used to facilitate initial transactions by providing early purchasers with recommendations, even though the population of actual users may be insufficient to facilitate actual user muses with a high degree of library similarity. In one embodiment, anonymous muses can provide recommendations in the initial phase of the app, and can be phased out as more live users adopt the app and offer recommendations. Optionally, anonymous muses may be retired in reverse order of popularity. In other words, anonymous muses which are unpopular or which generate few transactions may be removed first. Anonymous muses who generate large numbers of transactions may be kept longer.

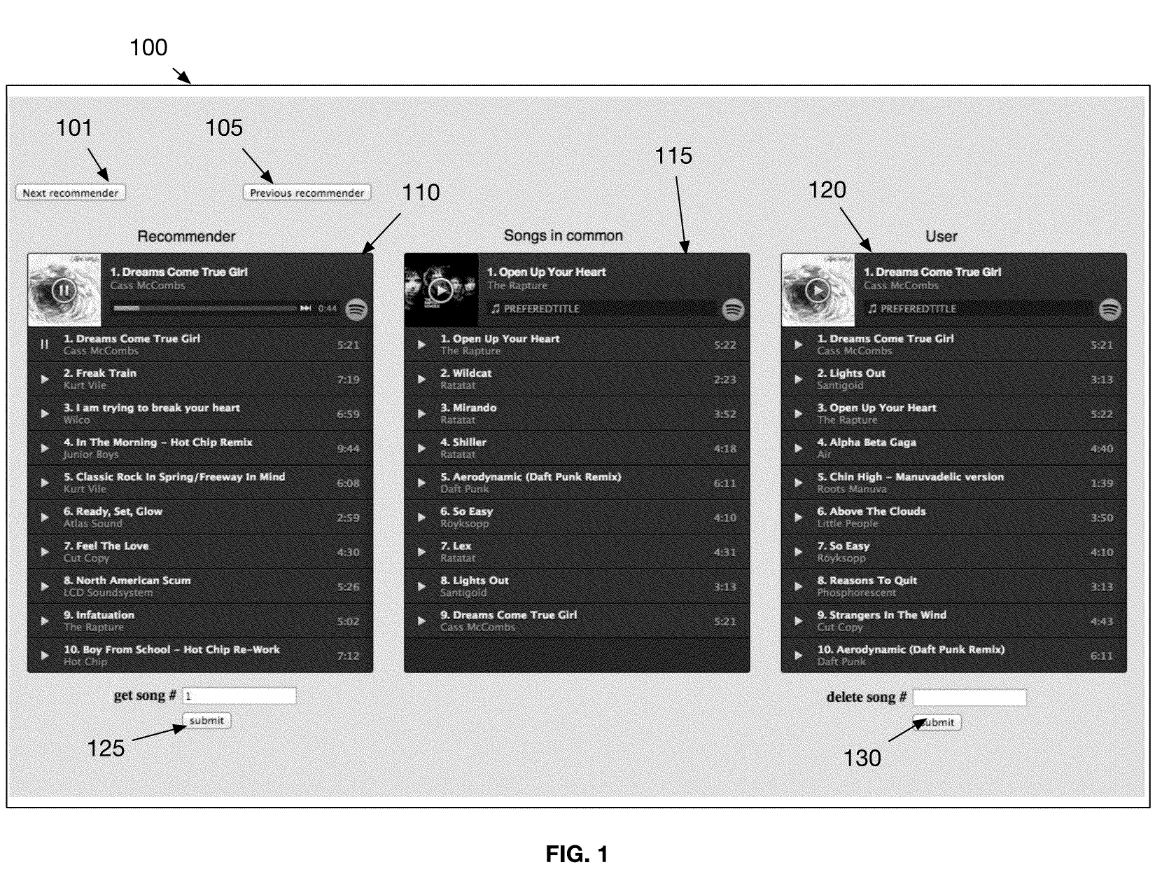

Referring to FIG. 1, an exemplary user interface for a content discovery system is illustrated. As shown, a user interface 100 may present a browsing user with a number of panels (e.g., three panels). A browsing user (i.e., requesting user) may desire to discover new music, discover the recommendations of muses and/or to purchase music. As shown, an exemplary first panel 120 may display a number of songs of a browsing user's library or selected playlist. In the pictured embodiment, the first panel 120 displays only a portion (i.e., ten songs) of the browsing user's playlist, but it will be appreciated that any number of songs from a playlist and/or a music library, including all songs, may be displayed.

In one embodiment, a second panel 110 represents at least a portion of a content library of a muse selected by the content discovery system. As shown, the second panel 110 comprises a number (e.g., 10) of the selected muse's most played songs. In one embodiment, the number of most played songs may change from time to time as the muse (or other users) plays the muse's songs. In other embodiments, a specific playlist of a muse may be displayed and/or even a muse's entire library. In one embodiment, the browsing user may view and/or listen to a number of the muse's top songs for free via a media player interface, but must pay to view and/or listen to additional songs.

The browsing user may purchase a song from the muse's library (e.g., via entering the corresponding song number into a selection box 125 or via pressing a “buy” button (not pictured). The browsing user may also delete songs from his own library via a selection box 130 and/or via pressing a “delete” button (not shown).

When a user purchases a song from a muse, the purchasing user is charged a purchase fee and acquires one or more copies, rights, and/or licenses to the purchased song such as: 1) the right to play the song via the interface 100, within the muse's library; 2) the right to add the song to the user's own library; 3) a digital rights management (“DRM”) enabled copy of the song playable through one or more interfaces or devices specified in the DRM restriction; and/or 4) a DRM-free copy of the song which may be played without restriction. In one embodiment, the purchase price of the song may vary depending on the copyrights the purchasing user desires. For example, the song may cost $0.10 for the right to play the song via the interface 100. Yet the price may increase to $0.99 for a DRM-free copy of the song. As discussed in detail below, a portion of the purchase fee may be credited to the muse.

The content discovery system may match the browsing user with a muse based on any number of characteristics. For example, the system may compare the libraries of the browsing user and the muse, and if a certain fraction of the items in the browsing user's library are also in the muse's library, the system may determine that the muse would be a good recommender for the browsing user. A user may also rank individual songs in their libraries with a numeric score or a number of stars. External systems that rank and match songs can be used to identify muses for playlists separately from the identification of muses for a library as a whole. Higher ranked songs may be given preference in identifying muses. To choose a muse, the system may take into account the number of times the muse profile has been viewed in the past, number of times the muse generated transactions (browsing and/or purchasing), the total amount received by the muse from browsing and/or purchasing commissions, the total number of and/or amount paid by the muse in browsing and/or purchasing commissions to other users, the number of song recommendations the muse has obtained from other muses, and/or the number of songs the muse has in their playlist. For each of the songs in the muse playlist, the system may consider the date the song was added, the number of times it was played and/or the number of users who also have that song in their playlist. Any of the above characteristics may also be applied to any subset of a muse's library (e.g. the muse's jazz playlist) to select a muse.

In one embodiment, the interface 100 comprises a “Next Recommender” button 101 and/or a “Previous Recommender” button 105, whereby a user may browse through libraries of muses selected by the system.

In one embodiment, a third panel 115 may provide the user with insight as to why he was matched to a current muse and/or whether that muse is an anonymous muse or a real user. As shown, a third panel 115 may display a cross reference of songs that both the browsing user and a selected muse have in common. For example, if 20% or more of the browsing user's library is also present in the muse's library, the user interface 100 may so inform the user by displaying the message, “You are a 20% match with this muse” in the third panel 115. In certain embodiments, the third panel 115 may be hidden from view.

Although not shown, a user may additionally or alternatively add songs to his library by searching a music catalog associated with the content discovery system. In one embodiment, the music catalog may contain all or a portion of the total set of songs of all user libraries. In another embodiment, the music catalog may contain all or a portion of the songs available through other music recommendation systems, such as SPOTIFY or ITUNES. If a user purchases a song explicitly through the music catalog, the cost may or may not be the same compared to purchasing the song via a muse's library.

If a user desires to add songs to his/her library, that are not in the music catalog, the songs may be imported from a CD, MP3, or other formats available to the user. The cost for importing songs from a music catalog may be different from costs associated with importing songs outside of the music catalog. Alternatively, importing songs may be free of costs. The music catalog may be centralized or decentralized. In embodiments of the invention with a centralized music catalog, the list of songs, and audio files associated with the songs, may be stored on a server and accessed thereon by browsing users. In embodiments of the invention with decentralized music catalog(s), the list(s) of songs and also the audio file(s) associated with them may be stored and served from the computers of individual users to other individual users.

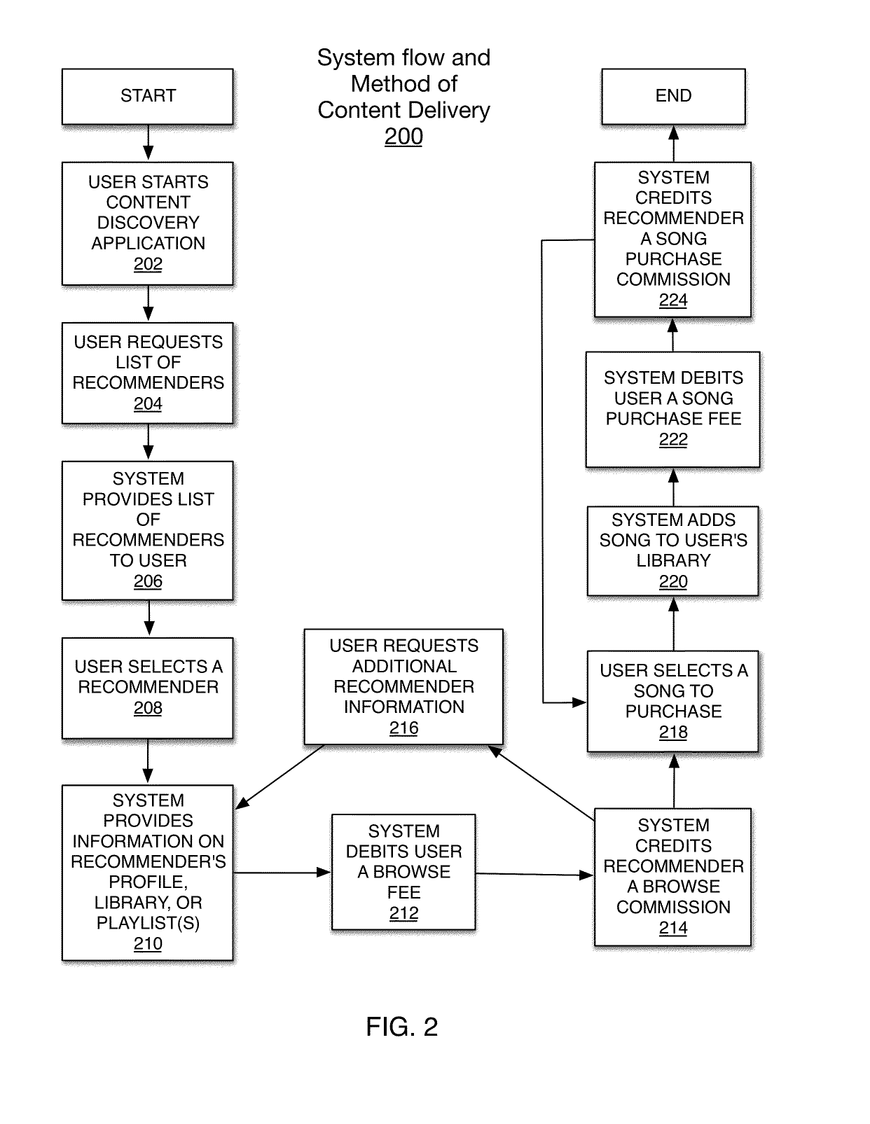

FIG. 2 illustrates a flow diagram for using an exemplary content delivery system 200. It will be appreciated that the flow process 200 depicted in FIG. 2 is but one embodiment, and steps may be added, deleted or reordered without deviating from the scope of the invention.

As shown, the process begins with a content discovery application 202 being accessed and/or run by a user. The content discovery application may be a client-side or server-side application, a web-based application, a mobile device app or a music-capable hardware device. One skilled in the art can appreciate that other means for executing the application may be used without deviating from the scope of the invention.

The application receives a request from a requesting or browsing user for a list of recommenders (i.e., “muses”) 204, and provides the requesting user with a list of one or more muses 206. As discussed above, the system may select muses to display to the requesting user based on any number of characteristics of: a muse, a muse's content library, a user and/or a user's content library. Optionally, the system may provide recommendations to the user without identifying an actual muse.

Next, at least one muse may be displayed to the requesting user. If multiple muses are presented (e.g., a list of muses), the requesting user may select a muse 208. Once a muse is selected or provided, the requesting user may be provided with at least a portion of the muse's library and/or playlists 210.

In one embodiment, a “browse purchase transaction fee” may be charged to a requesting user for the right to browse at least a portion of a muse's library. The browse purchase transaction fee may be charged to view any information of the muse or may be charged to allow the user to view more than a number of “top entries” of a muse's library. For example, a portion of a muse's library (e.g., 10 songs) may be designated “top entries” based on one or more of the following factors: number of plays by the muse, number of plays by other users, genre, cost, bpm, and other characteristics. The “top entries” may be freely viewed, played, downloaded, and/or previewed by a browsing user. However, when the user desires to view more of the muse's library, he must first enter into a browse purchase transaction.

A browse purchase transaction may trigger the following payment events:
1) The browsing user's funding account decreases by the amount of the browse purchase transaction fee 212,
2) the muse's funding account increases by a fraction of the cost of the fee 214,
3) One or more accounts representing the content discovery system, the artist, the record label, the music database provider, and/or other rights holders of the purchased song (collectively, “residual accounts”) may be increased by at least a portion of the remainder of the fee.

The amount paid by the browsing user may be greater than the amount paid to the muse; and therein the content discovery application system and/or rights holders may earn a profit by keeping at least a portion of the collected fees. As an example, a browse purchase transaction fee may be about $0.10 and a muse's recommendation fee may be about $0.02. The remainder of the browse purchase transaction fee may accrue to one or more of the residual accounts. Optionally, a muse may set his own fee. Thus, a very popular muse with a reputation for great recommendations may set his browse fee higher than an unpopular muse.

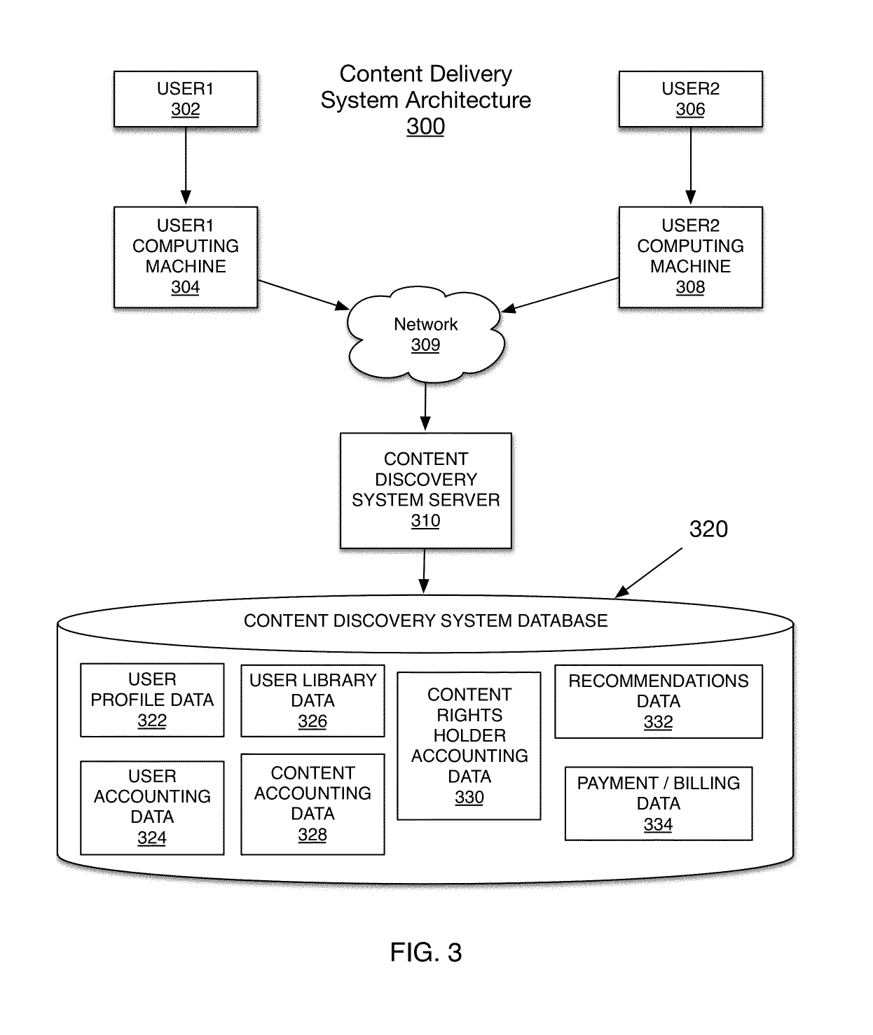

Each of the accounts described above, and/or any other accounting data described herein may be recorded within the CONTENT DISCOVERY SYSTEM DATABASE 320, in tables such as USER ACCOUNTING DATA 324, CONTENT ACCOUNTING DATA 328, CONTENT RIGHTS HOLDER ACCOUNTING DATA 330, and/or PAYMENT BILLING DATA 334 described below in reference to FIG. 3.

Still referring to FIG. 2, the user may request additional muse information from the application 216, which may result in an additional browse purchase. For example, the user may wish to know social media information, hobbies, physical location or contact information about the muse

In one embodiment, the system may allow a user to interact with a muse via email, texting, IM, Skype, etc. Such interaction may allow the muse and the user to discuss library content and May lead to additional browses and/or purchases from either party. Additional fees may be charged for such interactions.

After the system has provided the user with recommendation information, the user may then select a song to purchase 218. The application receives notification of a song to be purchased and a muse's library from which the song was discovered. The application then adds the purchased song to the user's library 220, charges the user a song purchase fee 222, and credits the muse a purchase commission 224. The remainder of the purchase fee may accrue to residual accounts. For example, the system may provide an artist fee to the underlying artist, a label fee to the record label, a performance fee to the performance rights organization, and/or a music database fee to a provider of music databases.

An exemplary content discovery application system may account for songs by integer number of songs, by currency (e.g. dollars and cents) related to the value of the songs, by tokens, which may optionally be convertible into currency, by a combination of these, or by other methods. In one embodiment, the amount paid by the purchasing user is greater than the amount paid to the copyright holder(s) plus the amount paid to the muse; and therein the content discovery application system earns profit. In one embodiment, the song purchase fee may be approximately $0.10 with $0.05 of the fee being credited to the muse. Alternately, the purchase price may be divided such that the copyright holder(s) are paid approximately 25% of the purchase price, the muse is paid approximately 25% of the purchase price, and the content discovery system accrues the remainder of the purchase price.

Furthermore, it may be beneficial to know when a user deletes songs from his/her library (see FIG. 1 at 130). In one embodiment, some or the entire purchase price of a song may be credited back to a user when the song is deleted from their library. One can appreciate that a user of an exemplary system may not be purchasing a digital file (e.g., mp3 file) of a song. Rather, the user may purchase “recommendations” from another user. The user may then use the system or another system to purchase or stream the recommended content.

Referring to FIG. 3, an exemplary content discovery system is illustrated. As shown, the content discovery system 300 comprises a content discovery server 310 and a content discovery database 320. One skilled in the art can appreciate that multiple servers and databases may be implemented.

A first user 302 may access the content discovery server 310 with a first computing machine 304 (e.g., general or specific purpose computer or mobile device) via a network 309. Simultaneously or at a different time, a second user 306 may access the content discovery server 310 with a second computing machine 308 via the network 309.

The content discovery system is configured to execute a content discovery system application. The system reads, processes, stores and/or retrieves data from the content discovery database 320, or from any other system capable of storing electronic data. In one embodiment, the content discovery database 320 may comprise one or more of the following data tables: USER PROFILE DATA 322, USER ACCOUNTING DATA 324, USER LIBRARY DATA 326, CONTENT ACCOUNTING DATA 328, CONTENT RIGHTS HOLDER ACCOUNTING DATA 330, RECOMMENDATIONS DATA 332 AND PAYMENT/BILLING DATA 334.

An exemplary content discovery app may be implemented with various configurations of hardware, software, and stored information. One or more types of databases and/or data schematics may be implemented for storing the content of a content discovery system. As such, one embodiment for storing information in a relational database is described. Data pertaining to a user's songs, muses, play count, music library, purchases, deletions, browses, and any other data relating to a user's music preference, activity, rankings, or other activity on or off the content management system may be stored. When a user is logged into the system, additional tables of data may be temporarily created or loaded either in RAM or on a magnetic storage medium, to enable faster access of data for the logged in user. The following list and descriptions of database structures and tables are intended to illustrate some embodiments of the invention.

To provide recommendations, a number of database tables may be employed. First, a USER-LIBRARY table 326 containing at least fields for MUSE_ID, SONG_ID, and PLAYCOUNT may be employed. The USER-LIBRARY table 326 may comprise a representation of each user in the system, both anonymous and live, and each song in those users' playlists.

Second, a CATALOG table comprising one or more of a SONG_ID, TITLE, ARTIST, TOTAL_PLAYCOUNT, and SONG_LINK may be provided. The CATALOG table may comprise an entry for each unique song in the USER-LIBRARY table 326. In one exemplary system, the SONG_LINK field contains a link to an external service, such as SPOTIFY or GROOVESHARK, where the song may be listened to.

Additionally, some embodiments may comprise a USER_SONGS table with entries containing at least the fields USER_ID, SONG_ID, and PLAYCOUNT. This table is similar to the USER-LIBRARY table 326, but contains songs for live muses. In the exemplary user interface shown in FIG. 1, the information in the USER_SONGS table may used to populate the first panel 120.

Some embodiments may comprise a USER_MUSE_OVERLAP table, with rows containing at least USER_ID, MUSE_ID, and SONG_ID. This table represents songs that appear in both the user's library and the muse's library and/or playlist. In the exemplary user interface shown in FIG. 1, the information in this table may be used to populate the third panel 115.

Some embodiments may comprise a MUSE_RECOMMENDATIONS table, containing at least USER_ID, MUSE_ID, and SONG_ID. This table is similar to the USER_SONGS table, but holds the songs of the muse currently being displayed to the user. In one embodiment, these songs may be displayed in order of descending play count. In the exemplary user interface shown in FIG. 1, the information in this table may be used to populate the second panel 110.

Some embodiments may comprise a PRIOR_MUSES table with rows containing at least USER_ID and MUSE_ID. This table contains the list of muses that a particular user has already browsed. The data in this table may optionally be hidden from the user interface.

Regarding the controls present in the user interface 100 illustrated in FIG. 1, some embodiments may provide a Next Recommender Button 101. This adds a row containing the MUSE_ID of the current muse to PRIOR_MUSES. The system then loads a new muse (see below for a description of “loading a new muse”).

Some embodiments may provide a Previous Recommender Button 105. This button causes the system to load a new muse that has already been viewed by the user (see below for a description of “loading a new muse”). This may optionally delete the MUSE ID of the current muse from PRIOR_MUSES.

Some embodiments may provide a Get Song # Button 125. This button updates the profile of the user by querying the USER_LIBRARY table for all rows with that SONG_ID. The result set provides a listing of each user in the system that owns that song. This result set is inserted into USER_MATCHES. The SONG_ID is also added to USER_SONGS and USER_MUSE_OVERLAPS.

Some embodiments may provide a Delete song # button 130. This deletes the row containing this SONG_ID from USER_SONGS, USER_MUSE_OVERLAP, and USER_MATCHES.

Loading a new muse happens, as described above, when a user presses the Next Recommender 101 or Previous Recommender 105 buttons, or when the page is refreshed. Continuing with the example of the user interface and table structure described above, this would cause the following actions to occur:
i. Delete temporary tables USER_MUSE_OVERLAP and MUSE_RECOMMENDATIONS.
ii. Select from the USER_LIBRARY a list of muses for the user table. Preferably this list will be ordered in decreasing order of the number of matches between a user and a particular muse.
iii. Select a new muse from the list of muses. Optionally, if a muse is sought which has not been viewed by this user before, the PRIOR_MUSES table can be used to exclude already viewed muses.
iv. Query the USER_LIBRARY table for the new muse's ID for a list of the muse's songs. In one embodiment, this list will be ordered in decreasing order of play count. Optionally, create a temporary table MUSE_SONGS to cache the muse's songs.
v. Select the top ten songs from the aforementioned list, create the MUSE_RECOMMENDATIONS table from this list, and display the table to the user.
vi. Identify the songs from MUSE_SONGS (or, query the USER_LIBRARY table to retrieve a list of the muse's songs) as well as in the USER_SONGS table, e.g. by an SQL join command, and add the matching songs to the USER_MUSE_OVERLAP table. Display the matching songs in the center pane of the UI.

In one embodiment, the content discovery application may offer additional features to the user by incorporating functions of one or more of the following applications. For example, the content discovery application may permit the user to play and/or store music onto a portable device capable of playing music. Further, the content discovery application may recognize and identify a song while it is playing (for example, by employing sound identification algorithms known in the art or by using a commercially available services such as SHAZAM™), import the song into the user's music library, allow for purchase of the song. Further, a user may create a playlist from their library of songs (e.g. “Ralph's Dance Music Playlist”).

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a flash memory device, such as a compact flash card or USB flash drive.

Some exemplary embodiments described herein are described as software executed on at least one computer, though it is understood that embodiments can be configured in other ways and retain functionality. The embodiments can be implemented on known devices such as a server, a personal computer, a smart phone, a tablet device, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

I claim:

1. A method for recommending media content, comprising:
providing, by a server communication device, to a browsing user of a client computing device, an interface for browsing media content of a plurality of available media libraries, each available media library associated with one of a plurality of users;
selecting, by the server communication device, from the plurality of available media libraries, a recommended media library associated with a recommending user to present to the client computing device;
wherein the recommended media library is selected based on a score generated by comparing at least a portion of a browsing user media library associated with the browsing user with at least a portion of the recommended media library; and
presenting, by the server computing device, to the browsing user, recommended information comprising media content associated with the recommended media library of the recommending user.

2. The method of claim 1, further comprising: providing, by the server computing device, a browsing commission to the recommending user when the browsing user browses the recommended information.

3. The method of claim 2, wherein the browsing commission is based on the generated score.

4. The method of claim 1, further comprising providing, by the server computing device, a purchase commission to the recommending user when the browsing user purchases media content associated with the recommended information.

5. The method of claim 1, further comprising:
providing, by the server computing device, a browsing commission to the recommending user when the browsing user browses the recommended information; and
providing, by the server computing device, a purchasing commission to the recommending user when the browsing user purchases media content associated with the recommended information

6. The method of claim 1, wherein the media content is selected from the group consisting of a digital audio file, video file, and a text file.

7. The method of claim 6, wherein the media content is a song stored as a digital audio file.

8. The method of claim 1, wherein the media content is songs, and the recommended information comprises a list of the recommending user's most played songs.

9. The method of claim 1, wherein the generated score is based on one or more of the group consisting of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.

10. A system for providing media content, comprising:
a server computing device having a processor for executing content discovery software modules stored on a memory,
a client computing device communicatively coupled to the server over a network, wherein the client computing device comprises a second processor for executing instructions from a machine readable storage,
wherein, the content discovery software modules are programmed for:
providing, to the client computing device, an interface for browsing media content of a plurality of available media libraries, each available media library associated with one of a plurality of users;
selecting, from the plurality of available media libraries, a recommended media library associated with a recommending user to present to a browsing user using the client device;
wherein the recommended media library is selected based on a score generated by comparing at least a portion of a browsing user media library of the browsing user with at least a portion of the recommended media library; and
presenting, to the client computing device, recommended information comprising media content associated with the recommended media library of the recommending user.

11. The system of claim 10, wherein the content discovery software modules are further programmed for:
providing a browsing commission to the recommending user when the browsing user browses the recommended information.

12. The system of claim 10, wherein the content discovery software modules are further programmed for:
receiving a browsing commission when the browsing user browses the recommended information.

13. The system of claim 10, wherein the content discovery software modules are further programmed for:
providing a purchase commission to the recommending user when the browsing user purchases media content of the recommended information.

14. The system of claim 10, wherein the content discovery software modules are further programmed for:
receiving a purchase commission when the browsing user purchases media content of the recommended information.

15. The system of claim 10, wherein the content discovery software modules are further programmed for:
providing a browsing commission to the recommending user when the browsing user browses the recommended information; and
providing, by the server computing device, a purchasing commission to the recommending user when the browsing user purchases media content associated with the recommended information

16. The system of claim 10, wherein the media content is a song stored as a digital audio file.

17. The system of claim 16, wherein the media content is songs, and the recommended information comprises a list of the recommending user's most played songs.

18. The system of claim 10, wherein the generated score is based on one or more of the group consisting of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.

19. A non-transitory computer-readable storage device containing a set of instructions that causes a server communication device in communication with a client computing device to perform a process comprising:
providing, by the server communication device, to a browsing user of the client computing device, an interface for browsing media content of a plurality of available media libraries, each available media library associated with one of a plurality of users;
selecting, by the server communication device, from the plurality of available media libraries, a recommended media library associated with a recommending user to present to the browsing user;
wherein the recommended media library is selected based on a score generated by comparing at least a portion of a browsing user media library of the browsing user with at least a portion of the recommended media library; and
presenting, by the server computing device, to the client computing device, recommended information comprising media content associated with the recommended media library of the recommending user.

20. The non-transitory computer-readable storage device of claim 19, wherein the generated score is based on one or more of the group consisting of: an overlap of at least a portion of the media content in the browsing user media library and the recommended media library, a number of times the recommended media library has been browsed in the past, a number of times the recommending user has received a browsing commission, a number of times the recommending user has received a purchasing commission, an amount of money the recommending user has received from purchasing commissions, an amount of money the recommending user has received from browsing commissions, an amount of money the recommending users has paid to other users in browsing commissions, an amount of money the recommending users has paid to other users in purchasing commissions, number of times the recommending user has paid a browsing commission to other users, a number of times the recommending user has paid a purchasing commission to other users, a number of media content recommendations the recommending user has obtained from other users, an amount of media content available in the recommended media library, a date media content in the recommended media library was added, a number of times media content in the recommended media library has been played by the recommending user, a number of times media content in the recommended media library has been played by the browsing user, a number of users who have media content from the recommended media library in their user media libraries, a ranking of media content in the recommended media library by the recommending user, and a ranking of media content in the recommended media library by the browsing user.
